(19) United States
(12) Patent Application Publication
(10) Pub. No.: US 2002/0065067 A1
(43) Pub. Date: May 30, 2002

(54) Method for determining whether data service connectivity is supported in a wireless communication system

(76) Inventors: Arjun Khare, San Diego, CA (US); Nischal Abrol, San Diego, CA (US); Harold C. Gilkey, San Diego, CA (US)

Correspondence Address: Qualcomm Incorporated, Patents Department, 5775 Morehouse Drive, San Diego, CA, 92121-1714, US

(21) Appl. No.: 09/728,199

(22) Filed: Nov. 30, 2000

(51) Int. Cl. H04B 1/38

(52) U.S. Cl. 455/414; 455/566

(57) ABSTRACT

A method for a wireless device to automatically and dynamically determine if the current system in which it is operating is capable of offering data service connectivity. The present invention requires no intervention on the part of the user. According to the method of the present invention, a call origination signal from a wireless device is automatically transmitted to a base station. The call origination signal contains a request for electronic data transmission services. The wireless device detects whether a reply to the call origination signal has been received from the base station. If a reply has been received, the wireless device detects whether the data service request has been rejected. If the detected reply does not reject the data service request, then an indication of availability of the data service is displayed on the wireless device. If the detected reply does reject the data service request, then an indication of non-availability of the data service is displayed on the wireless device.

### BACKGROUND OF THE INVENTION

1. Field of the Invention

The present invention relates generally to the field of mobile communications. More particularly, the present invention relates to a method for determining whether electronic data transmission services are available for a wireless device.

2. Related Art

A variety of multiple access communication systems have been developed for transferring information among a large number of system users. Typically, in such systems, a user of a wireless device must make an actual attempt to connect to an electronic data transmission service, such as the Internet, to determine whether data service connectivity is supported. Failure to connect the wireless device to the electronic data transmission service can indicate one of two things. Either the system does not support data service connectivity, or the system was heavily loaded, making data service connectivity currently unavailable. The user, short of calling the service provider, never fully knows why the data service connection failed.

What is needed is a method for enabling a wireless device to automatically indicate its ability for wireless data service connectivity to the user. What is also needed is the ability to have the wireless device automatically change the indication as the ability for data service connectivity changes. Thus, what is further needed is a method for a wireless device to automatically determine whether or not data service connectivity is available without user intervention.

### SUMMARY OF THE INVENTION

The present invention satisfies the above mentioned needs by providing a method for a wireless device to automatically and dynamically determine if the communication system in which the wireless device is operating is capable of offering data service connectivity. The present invention requires no interaction on the part of the user. According to the method of the present invention, a call origination signal from a wireless device is automatically transmitted to a base station. Alternatively, the wireless device might scan overhead messages sent by the base station—such as for example Extended System Parameters messages—to determine if the base station supports data services. Such indications could be PZID, MAC_CF_SUPPORTED, or any other indication that might be added to the standard later. The call origination signal contains a request for electronic data transmission services. The wireless device detects whether a reply to the call origination signal has been received from the base station. If a reply has been received, the wireless device detects whether the electronic data transmission service request has been rejected. If the detected reply does not reject the electronic data transmission service request, then an indication that data service connectivity is available is displayed via the user-interface of the wireless device. The indication could be an LED, sound, vibration, etc. Thus, the indication is not restricted to a display on an LCD screen. If the detected reply does reject the electronic data transmission service request, then an indication that data service connectivity is not available is displayed on the user-interface of the wireless device.

Most of the communications performed during the determination of whether access to electronic data transmission services is available are done over paging and access channels. Potentially few message units are used during the communication. Therefore, only a minimal amount of interference is introduced to the communication system.

The method of the present invention conforms to the IS95B standard, which contains information on how a base station and mobile device communicate. The method of the present invention also conforms to the IS2000 standard. Thus, no changes to the IS95B standard are required, and more importantly, no hardware or software changes to existing base stations are required.

Further features and advantages of the invention, as well as the structure and operation of various embodiments of the invention, are described in detail below with reference to the accompanying drawings.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1A is a diagram illustrating an exemplary communication system in which the present invention may be implemented.

FIG. 1B is a block diagram illustrating an exemplary wireless device.

FIG. 2A, 2B, 2C, and 2D are diagrams illustrating exemplary symbols/icons for display on a wireless device's user-interface indicating to the user whether data service connectivity is or is not available according to an embodiment of the present invention.

FIG. 3 is a flow diagram illustrating origination of a data query from a wireless device to a base station when a channel assignment is received from the base station according to an embodiment of the present invention.

FIG. 4 is a flow diagram illustrating origination of a data query from a wireless device to a base station when a rejection with reason is received from the base station according to an embodiment of the present invention.

FIG. 5 is a flow diagram illustrating origination of a data query from a wireless device to a base station when a rejection without reason is received from the base station according to an embodiment of the present invention.

FIG. 6 is a flow chart illustrating a method for a wireless device to automatically and dynamically determine whether the communication system in which the wireless device is operating offers data service connectivity according to an embodiment of the present invention.

FIG. 7 is a flow chart illustrating an alternative method for a wireless device to automatically and dynamically determine whether the communication system in which the wireless device is operating offers data service connectivity that employs a system identification/network identification (SID/NID) list according to an embodiment of the present invention.

The features, objects, and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE PREFERRED EMBODIMENTS

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

The present invention can be applied for use in various types of wireless communication systems. The preferred mode of operation is in a CDMA system. However, the principals of the invention can be readily adopted for use in TDMA, FDMA, WCDMA, HDR, or other types of wireless communication systems.

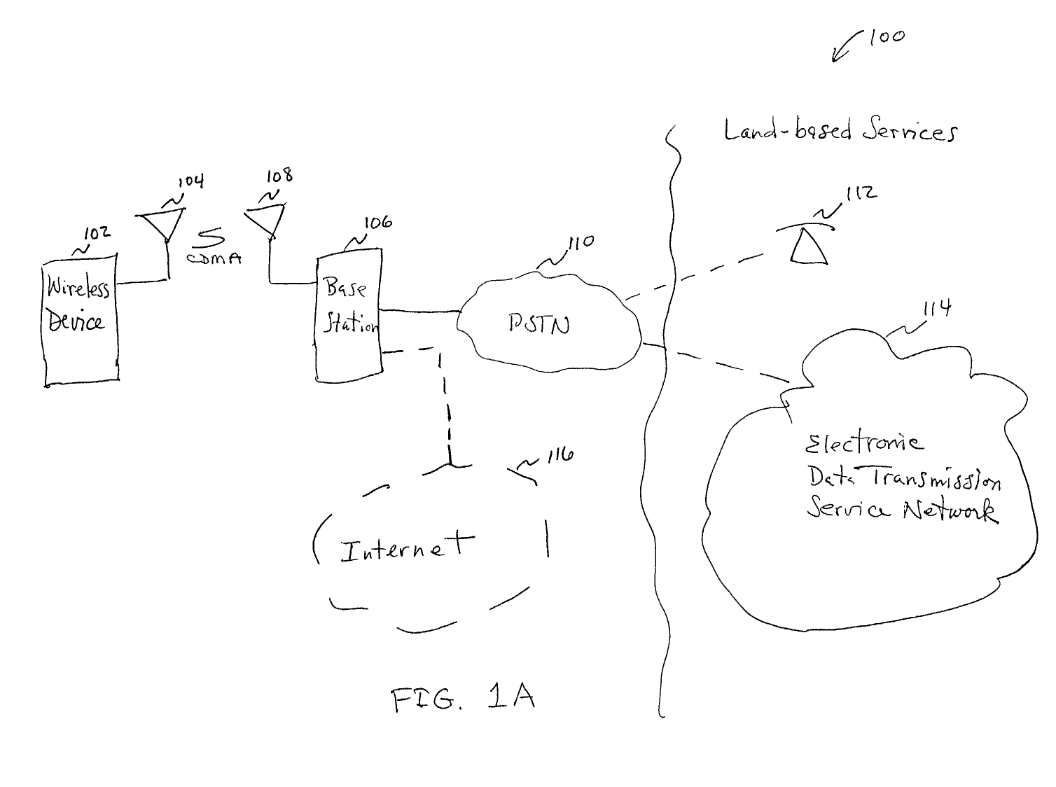

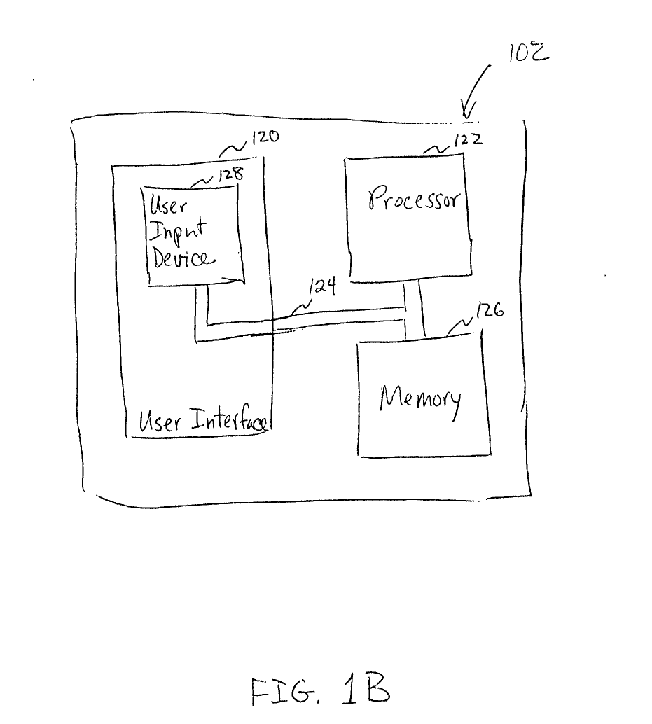

The present invention is a method for determining data service connectivity for a wireless device in a wireless communication system. FIG. 1 is a diagram of an exemplary wireless communication system 100 in which the present invention may be implemented. Communication system 100 comprises a wireless device 102 having a first antenna 104, a base station 106 having a second antenna 108, and a public switched telephone network (PSTN) 110. Base station 106 is coupled to PSTN 110. PSTN 110 is shown in phantom to be coupled to land-based services, such as voice (a telephone 112) and data (an electronic data transmission service network 114). In one embodiment, base station 106 may also be coupled to an IWF (inter-working function) and the INTERNET™ (shown in phantom in FIG. 1), in addition to being coupled to PSTN 110.

Examples of wireless device 102 may include, but are not limited to, a cellular telephone, a personal digital assistant (PDA), a pager, etc., or any combination thereof. Base station 106 is a fixed device for enabling a wireless device, such as wireless device 102, to communicate with land-based voice and data services, such as telephone 112 and electronic data transmission service network 114. Although base station 106 is shown as being capable of connecting to electronic data transmission service network 114 via PSTN 110, not all base stations have the ability to connect to electronic data transmission services. Base station 106 is also capable of enabling wireless device 102 to communicate with other wireless devices (not shown). Wireless device 102 and base station 106 communicate over the air via first and second antennas 104 and 108, respectively.

The present invention also provides the user of wireless device 102 with an indication of whether or not data service connectivity is available in the particular area in which the user is presently located. The user is provided this indication without having to first make a connection attempt. A determination is automatically made as to whether access to electronic data transmission services is available without any user interaction. Once it is determined whether access to electronic data transmission services is available, an indicator is displayed to the user via the user-interface of wireless device 102.

FIG. 1B is a block diagram of an exemplary wireless device 102. In a preferred embodiment, wireless device 102 is a wireless telephone. Wireless telephones are stand alone units that exchange radio frequency (RF) signals via wireless communication systems, such as wireless communication system 100. Examples of wireless telephones include portable, mobile, or fixed cellular and satellite telephones. In alternative embodiments, wireless device 102 may be any device that interfaces to a wireless communication system, such as a pager, a personal digital assistant (PDA), a wireless computer, etc.

Wireless device 102 comprises a user interface 120, one or more processors, such as processor 122, an interface 124, and memory 126. User interface 120 includes a user input device 128 and one or more software components that reside in memory 126. User input device 128 is connected to interface 124. Interface 124 is connected to processor 122 and memory 126.

User input device 128 may be any device that accepts input from a user. In a preferred embodiment, user input device 128 is a keypad on wireless device 102. In alternative embodiments, user input device 128 may be a keyboard, a touch screen, any other device that can accept user input, or a combination thereof.

User interface 120 comprises a display as well as user input device 128. The display enables wireless device 102 to output information to a user. The display may include, but is not limited to, light emitting diodes (LEDs), a liquid crystal display (LCD), a video display, any other display known to persons skilled in the relevant art(s), or any combination thereof.

Processor 122 comprises one or more processors that have the capability to process computer software in the form of lines of executable code. The lines of executable code reside in memory 126 and may comprise commands from a plurality of computer programming languages. Processor 122 may comprise processing capability dispersed among one or more application specific integrated circuits (ASICs) or other hardware capable of processing computer software. ASICs are well known to persons skilled in the relevant art(s). The Mobile Station Modem™ chip is an ASIC suited for wireless device 102 because it is designed for use in wireless communication applications and incorporates code division multiple access (CDMA) functionality. Exemplary processors 122 may also include the Advanced RISC Machines (ARM®) microprocessor and the Intel 186 processor.

Interface 124 is any communication bus that allows the functional connectivity of components within wireless device 102.

Memory 126 is any storage medium capable of storing information. Examples of memory 126 include short term memory, long term memory, random access memory (RAM), read only memory (ROM), non-volatile memory, removable memory such as a floppy disk, or any other memory that can be used to store computer code or information processed by computer software. Memory 126 may be dispersed among one or more hardware storage medium components. In a preferred embodiment, memory 126 can retain stored data even when wireless telephone 102 is powered down.

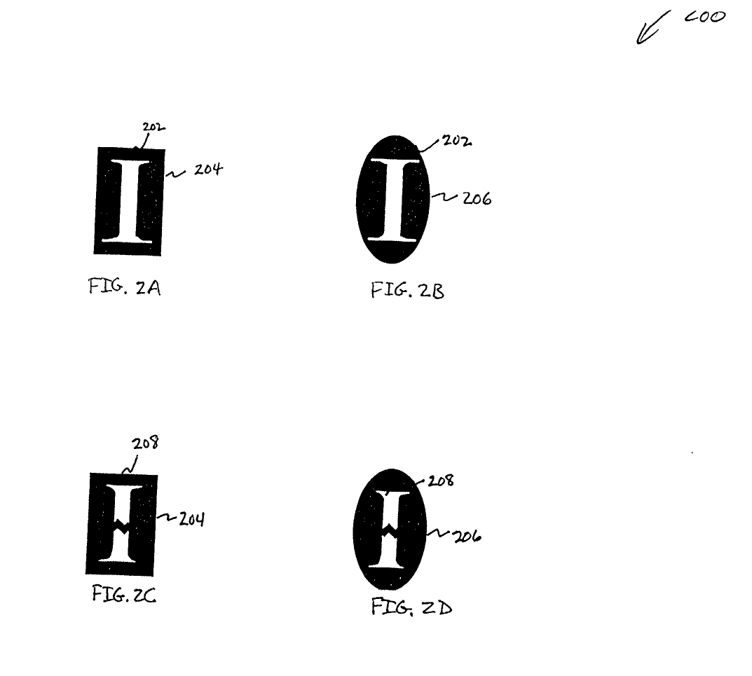

FIGS. 2A, 2B, 2C, and 2D are diagrams illustrating exemplary symbols/icons 200 for display on wireless device 102's user-interface that indicate whether data service connectivity is or is not available according to an embodiment of the present invention. FIG. 2A shows a letter “I” 202 enclosed within a rectangular region 204 for indicating that access to electronic data transmission services is available. FIG. 2B shows letter “I” 202 enclosed in an oval region 206 for indicating that access to electronic data transmission services is available. FIG. 2C shows a broken letter “I” 208 enclosed in rectangular region 204 for indicating that access to electronic data transmission services is unavailable. FIG. 2D shows broken letter “I” 208 enclosed in oval region 206 for indicating that access to electronic data transmission services is unavailable. As the ability for access to electronic data transmission services changes, symbol/icon 200 dynamically changes accordingly.

Although the present invention uses symbols/icons representative of the letter “I” enclosed in rectangular and oval regions, the present invention is not limited to these symbols/icons. One skilled in the art would know that other letters within object regions or other symbols/icons may be used as indicators without departing from the scope and spirit of the present invention. Other examples of indicators that may be used to display the availability/unavailability of data service connectivity may include, but are not limited to, LED(s), a buzz or beep sound, a blinking/non-blinking indicator, etc.

As previously stated, not all wireless service providers support access to electronic data transmission services. Also, access to electronic data transmission services may not be supported in all areas. Therefore, wireless device 102 may not be able to access electronic data transmission service network 114 because the communication system in which wireless device 102 is located does not support data service connectivity or the service provider for wireless device 102 either does not support data in its infrastructure or does provide data service, but has not yet rolled out this service in the current cell.

Access to electronic data transmission services is determined via communications between wireless device 102 and base station 106. The present invention is applied automatically by wireless device 102. No user interaction is required. Wireless device 102 originates a call requesting electronic data transmission services to base station 106. Base station 106 responds in one of three ways: (1) a channel assignment; (2) a release order specifying that the requested service option is not supported; or (3) a release order with no reason specified.

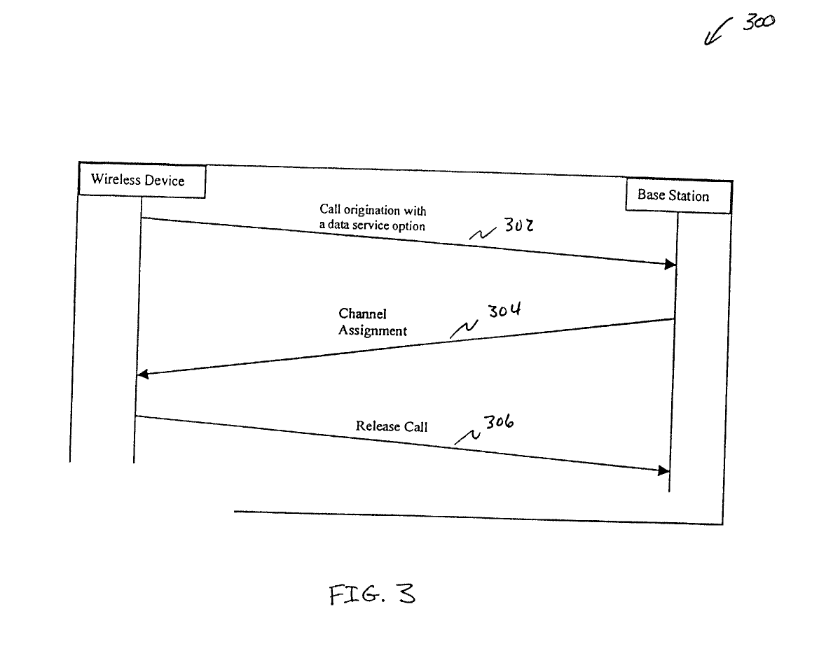

FIG. 3 illustrates the origination of a call from wireless device 102 to base station 106 when a channel assignment is received from base station 106. The process begins when wireless device 102 sends a data query 302 to base station 106. The data query is an inquiry as to whether base station 106 is capable of providing electronic data transmission services to wireless device 102. The data query is originated on an access channel.

Base station 106 responds with a traffic channel assignment message 304 on a paging channel. The receipt of the traffic channel assignment indicates that electronic data transmission services are accessible. All further communication between wireless device 102 and base station 106 takes place on the assigned traffic channel.

Wireless device 102 releases the call immediately, sending the release message 306 on the assigned traffic channel. The traffic channel is therefore allocated for a very short time. No actual data traffic takes place on the channel. Thus, the user should not be charged by the service provider. Some messaging/signalling does take place on the traffic channel, but this messaging does not carry user data (it is used in setting up the call).

In the case of a channel assignment message from base station 106 to wireless device 102, wireless device 102 will detect the potential for data service connectivity. The potential for data service connectivity is displayed to the user using one of the symbols/icons shown in FIGS. 2A and 2B. However, this does not mean that wireless device 102 will actually be able to make a data service connection. Other reasons may prevent the data service connection from occurring. For example, communication system 100 may be heavily loaded when the user attempt is eventually made. The call may fail due to lack of resources on base station 106. A channel assignment message may lead to service negotiation. While base station 106 and wireless device 102 are both capable of making a data service connection, base station 106 and wireless device 102 may use different service options. For example, base station 106 may only offer service option 7, which provides Rate Set 1 packet data, while wireless device 102 may only offer service option 15, which provides Rate Set 2 packet data. Other reasons that may prevent a user from accessing electronic data transmission services include, but are not limited to, the user not paying their bills or the user not signing up for electronic data transmission services with the service provider.

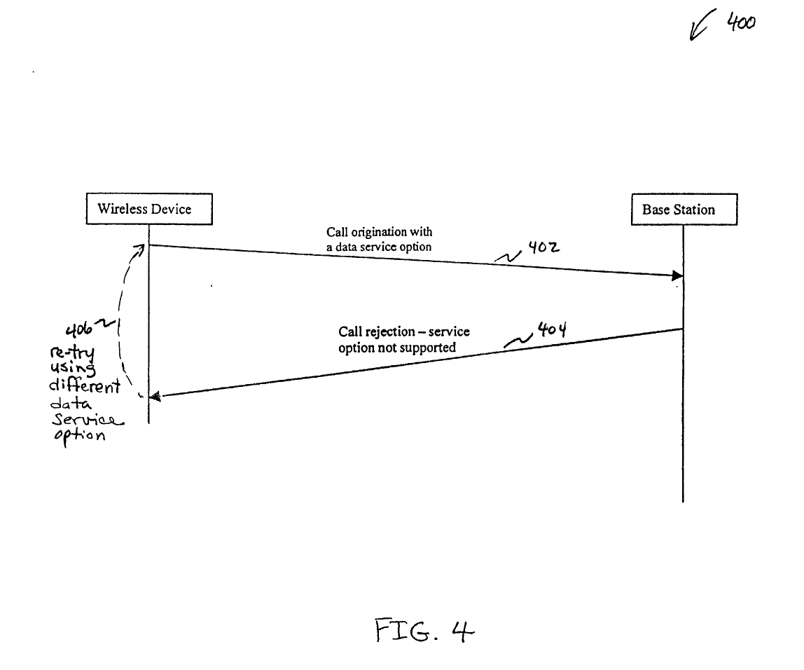

FIG. 4 is a flow diagram illustrating origination of a data query from a wireless device to a base station when a rejection with reason is received from the base station. The process begins when wireless device 102 sends a data query 402 to base station 106. The data query is an inquiry as to whether base station 106 is capable of providing electronic data transmission services to wireless device 102. The data query is originated on an access channel.

Base station 106 responds with a release order 404 on the paging channel. The release order specifies that a requested service option is not supported. The exact service option requested by wireless device 102 depends on the system configuration. For example, in a Quick Net Connect system, wireless device 102 may ask for service option 12. In a packet data system, wireless device 102 may ask for one of service options 7 or 15. Service option 7 provides Rate Set 1 packet data while service option 15 provides Rate Set 2 packet data. The receipt of the release order indicates that electronic data transmission services are not accessible. An indicator showing that data service connectivity is not available will be displayed to the user of wireless device 102 using one of the symbols/icons shown in FIGS. 2C and 2D.

Wireless device 102 may make additional query attempts 406 requesting a different service option, but this step is optional and at the discretion of wireless device 102. The list of service options to try is configured by the respective service provider of wireless device 102. If step 406 is not executed, wireless device 102 has no further interaction with base station 106 regarding the inquiry of electronic data transmission service availability.

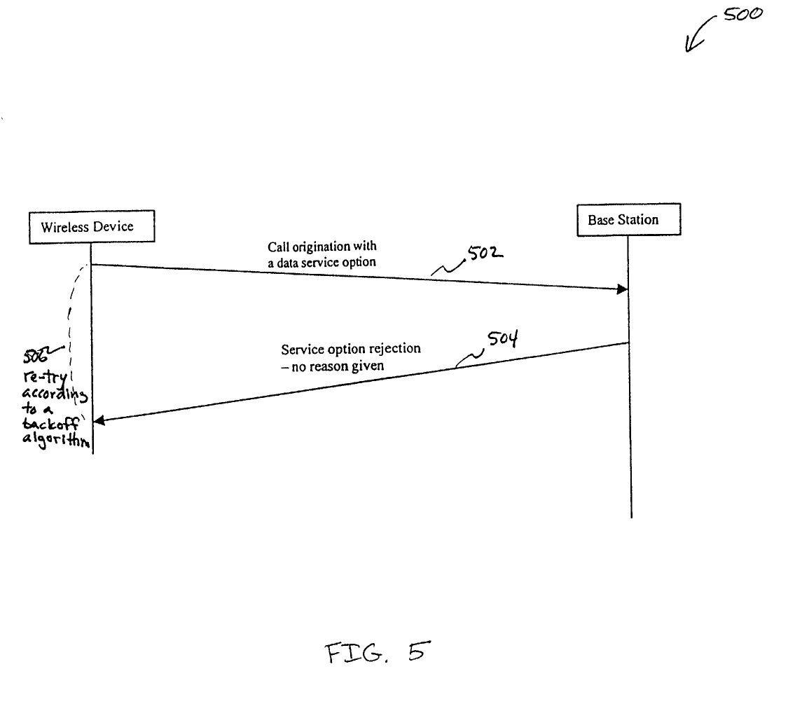

FIG. 5 is a flow diagram illustrating origination of a data query from a wireless device to a base station when a rejection without reason is received from the base station. The process begins when wireless device 102 sends a data query 502 to base station 106. The data query is an inquiry as to whether base station 106 is capable of providing electronic data transmission services to wireless device 102. The data query is originated on an access channel.

Base station 106 responds with a release order 504 on the paging channel. The release order does not provide any reason for failing to provide electronic data transmission services. Although this is considered an inconclusive result, it is assumed that access to electronic data transmission services is not available. An indicator showing that data service connectivity is not available will be displayed to the user of wireless device 102 using one of the symbols/icons shown in FIGS. 2C and 2D.

Wireless device 102 may make additional query attempts 506, but this step is optional and at the discretion of wireless device 102. If step 506 is not executed, wireless device 102 has no further interaction with base station 106 regarding the inquiry of electronic data transmission service availability.

The method of the present invention is performed when wireless device 102 powers-up and when wireless device 102 detects a change in the system identification/network identification (SID/NID). Wireless devices, such as wireless device 102, detect SID/NID changes by monitoring the paging channel. The detection of SID/NID changes is well known in the art. A change in SID/NID usually indicates a change in the inter-working function (IWF) which is responsible for connecting base station 106 to electronic data transmission services.

The method of the present invention is also performed when inconclusive results are obtained, such as when base station 106 responds with a release order with no reason specified. Upon receipt of the release order with no reason specified, the method of the present invention may be repeated using a backoff algorithm, such as a linear backoff algorithm. The backoff algorithm is used to restrict the frequency with which the method of the present invention is repeated. Also, when wireless device 102 is in a SID/NID area with no data service connectivity potential, wireless device 102 will perform the method of the present invention periodically to determine whether the SID/NID's data service connectivity capabilities have changed.

By restricting the frequency with which the method of the present invention is applied, wireless device 102 accesses communication system 100 very infrequently. This introduces minimal interference into communication system 100, and therefore, has minimal impact on system capacity.

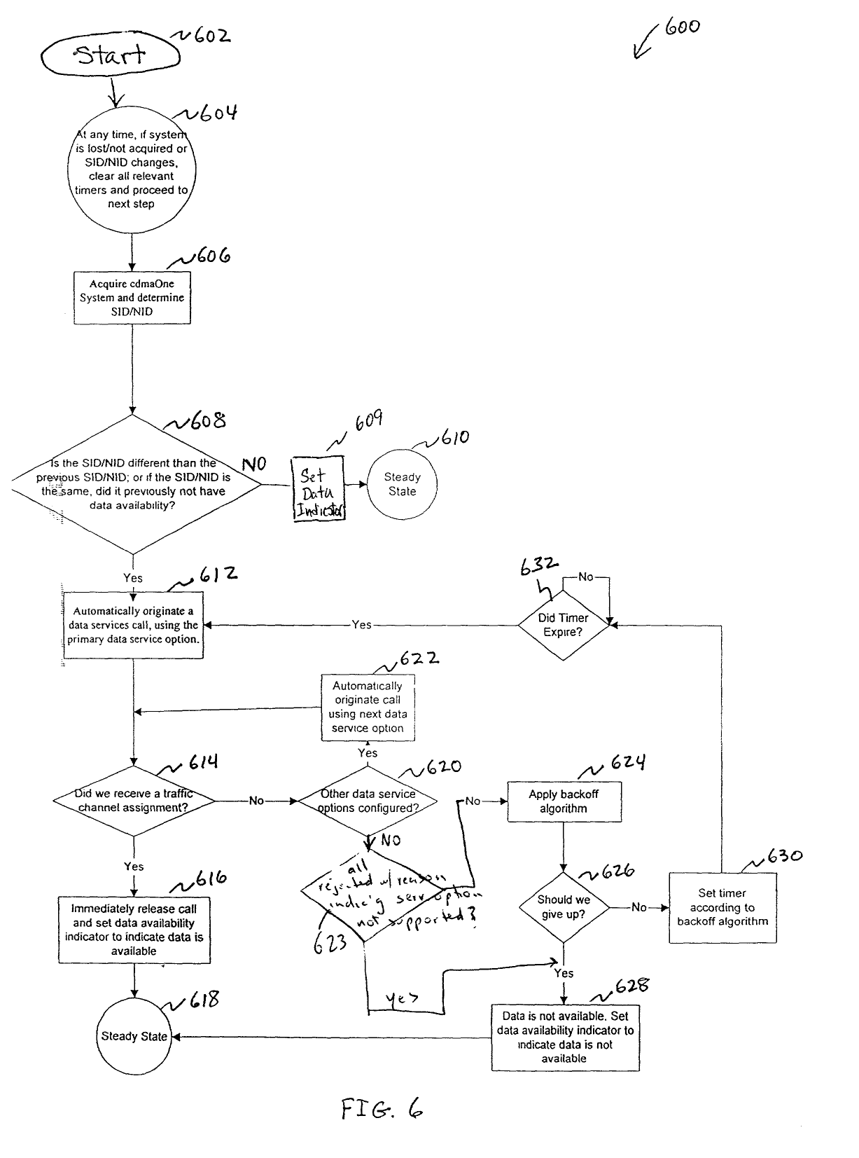

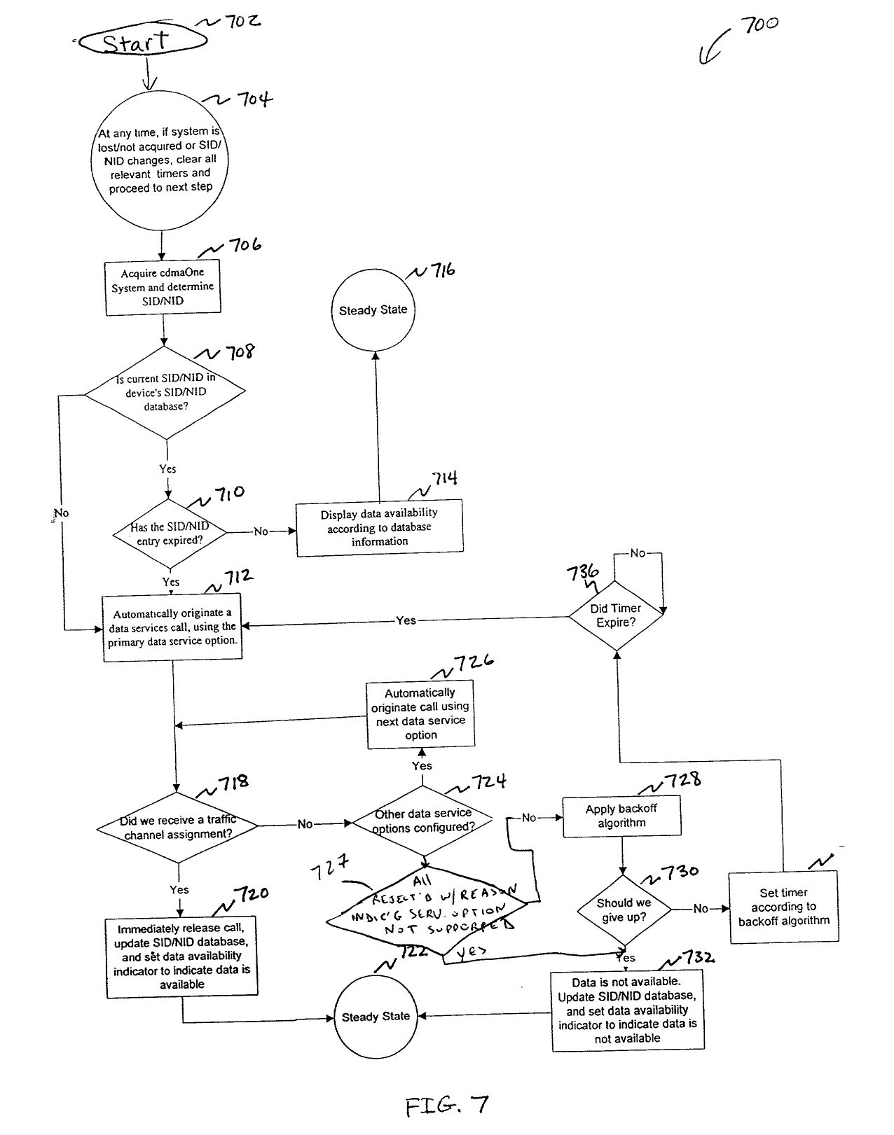

The present invention may be implemented using hardware, firmware, software, or a combination thereof. The present invention may also be implemented in one or more processors operating in wireless device 102 (as described in FIG. 1B). In one embodiment, the invention is directed toward one or more processor systems, operating in wireless device 102, capable of carrying out the functionality described below in FIG. 6. In another embodiment, the invention is directed toward one or more processor systems, operating in wireless device 102, capable of carrying out the functionality described below in FIG. 7.

FIG. 6 is a flow chart illustrating a method for a wireless device to automatically and dynamically determine whether the communication system in which the wireless device is operating offers data service connectivity. The steps of FIG. 6 may be implemented in hardware, firmware, software, or a combination thereof. The process begins with step 602, where control immediately passes to step 604.

In step 604, if the system is lost/not acquired or the SID/NID changes, all relevant timers are cleared. Control then passes to step 606.

In step 606, communication system 100 is acquired and the SID/NID is determined. Control then passes to decision step 608.

In decision step 608, it is determined whether the SID/NID is different than the previous SID/NID or, if the SID/NID is the same, whether it previously supported data service availability. If the SID/NID is not different from the previous SID/NID and the SID/NID supports data service availability, control then passes to step 609.

In step 609, the data indicator is set to indicate whether data is available. Control then passes to step 610.

In step 610, the system operates in the steady state mode in which normal operations of wireless device 102 are provided.

Returning to decision step 608, if the SID/NID is different from the previous SID/NID or, if the SD/NID is the same, but does not support data service availability, control then passes to step 612.

In step 612, wireless device 102 automatically originates an electronic data transmission service call using a primary data service option. Control then passes to decision step 614.

In decision step 614, it is determined whether a traffic channel assignment was received from base station 106. If a traffic channel assignment was received from base station 106, then control passes to step 616.

In step 616, wireless device 102 immediately releases the call. Wireless device 102 also sets the data availability indicator (symbol/icon) to indicate that electronic data transmission services are available. Control then passes to step 618.

In step 618, the system operates in the steady state mode in which normal operations of wireless device 102 are provided.

Returning to decision step 614, if a traffic channel assignment was not received, control then passes to decision step 620. In decision step 620, it is determined whether other data service options have been configured for wireless device 102. If other data service options have been configured for wireless device 102, then control passes to step 622.

In step 622, wireless device 102 automatically originates an electronic data transmission service call using the next data service option. Control then passes back to step 614.

Returning to decision step 620, if other data service options have not been configured for wireless device 102, control then passes to step 624. In step 624, a backoff algorithm, such as a linear backoff algorithm, is applied. The backoff algorithm is used to restrict the frequency with which the inquiry of data service connectivity is repeated. Control then passes to decision step 626.

In decision step 626, it is determined whether wireless device 102 should give up its inquiry as to whether electronic data transmission services are available in communication system 100, based upon the linear backoff algorithm. If it is determined that wireless device 102 should give up its inquiry as to whether electronic data transmission services are available in communication system 100, control then passes to step 628.

In step 628, wireless device 102 sets the data availability indicator (symbol/icon) to indicate that electronic data transmission services are not available. Control then passes to step 618.

Returning to decision step 626, if it is determined that wireless device 102 should not give up its inquiry as to whether electronic data transmission services are available in communication system 100, control then passes to step 630.

In step 630, a timer is set according to the backoff algorithm. The timer determines when the next inquiry should occur. Control then passes to decision step 632.

In decision step 632, it is determined whether the timer has expired. If the timer has not expired, control remains with step 632. If the timer has expired, control is passed back to step 612, where wireless device 102 originates another electronic data transmission service call query.

In an alternative embodiment, wireless device 102 stores a list of SID/NID pairs along with each SID/NID's data service connectivity potential. When wireless device 102 enters one of these SID/NID areas, wireless device 102 can examine the list to determine whether data service connectivity is available. The list can be formulated a number of ways. For example, the service provider can provide the list as part of a preferred roaming list. Alternatively, wireless device 102 can automatically store the last n SID/NID areas it has checked.

FIG. 7 is a flow chart illustrating an alternative method for a wireless device to automatically and dynamically determine whether the communication system in which the wireless device is operating offers data service connectivity that employs the SID/NID list. This alternative method further reduces system load. The steps of FIG. 7 may be implemented in hardware, firmware, software, or a combination thereof. The process begins with step 702, where control immediately passes to step 704.

In step 704, if communication system 100 is lost or has not been acquired, or the SIDINID changes, all relevant timers are cleared. Control then passes to step 706.

In step 706, wireless device 102 acquires communication system 100 and determines the SID/NID for communication system 100. Control then passes to decision step 708.

In decision step 708, it is determined whether the current SID/NID is in wireless device 102's SID/NID database. If it is determined that the current SID/NID is in wireless device 102's SID/NID database, then control passes to decision step 710.

In decision step 710, it is determined whether the SID/NID entry has expired. If the current SID/NID entry has not expired, control then passes to step 714.

In step 714, the user interface of wireless device 102 will display data service availability to reflect the information from the SID/NID database. Control then passes to step 716.

In step 716, the system operates in the steady state mode in which normal operations of wireless device 102 are provided.

Returning to decision step 708, if it is determined that the current SID/NID is not in wireless device 102's SID/NID database, control passes to step 712.

Returning to step 710, if it is determined that the SID/NID entry has expired, control passes to step 712.

In step 712, wireless device 102 automatically originates an electronic data transmission service call using a primary data service option. Control then passes to decision step 718.

In decision step 718, it is determined whether a traffic channel assignment was received from base station 106. If a traffic channel assignment was received from base station 106, then control passes to step 720.

In step 720, wireless device 102 immediately releases the call. Wireless device 102 also sets the data availability indicator (symbol/icon) to indicate that electronic data transmission services are available. Control then passes to step 722.

In step 722, the system operates in the steady state mode in which normal operations of wireless device 102 are provided.

Returning to decision step 718, if a traffic channel assignment was not received, control then passes to decision step 724. In decision step 724, it is determined whether other data service options have been configured for wireless device 102. If other data service options have been configured for wireless device 102, then control passes to step 726.

In step 726, wireless device 102 automatically originates a electronic data transmission services call using the next data service option. Control then passes back to step 718.

Returning to decision step 724, if other data service options have not been configured for wireless device 102, control then passes to step 728. In step 728, a backoff algorithm, such as a linear algorithm, is applied. The backoff algorithm is used to restrict the frequency in which the inquiry of data service connectivity is repeated. Control then passes to decision step 730.

In decision step 730, it is determined whether wireless device 102 should give up its inquiry as to whether electronic data transmission services are available in communication system 100. If it is determined that wireless device 102 should give up its inquiry as to whether electronic data transmission services are available in communication system 100, control then passes to step 732.

In step 732, wireless device 102 sets the data availability indicator (symbol/icon) to indicate that electronic data transmission services are not available. The SID/NID database is also updated to reflect the information obtained for the current SID/NID. Control then passes to step 722.

Returning to decision step 730, if it is determined that wireless device 102 should not give up its inquiry as to whether electronic data transmission services are available in communication system 100, control then passes to step 734.

In step 734, a timer is set according to the backoff algorithm. The timer determines when the next inquiry should occur. Control then passes to decision step 736.

In decision step 736, it is determined whether the timer has expired. If the timer has not expired, control remains with step 736. If the timer has expired, control is passed back to step 712, where wireless device 102 originates another electronic data transmission service call query.

Conclusion

The previous description of the preferred embodiments is provided to enable any person skilled in the art to make or use the present invention. While the invention has been particularly shown and described with reference to preferred embodiments thereof, it will be understood by those skilled in the art that various changes in form and detail may be made therein without departing from the spirit and scope of the invention. Thus, the breadth and scope of the present invention should not be limited by any of the above-described embodiments, but should be defined only in accordance with the following claims and their equivalents.

What is claimed is:

1. A method for determining data communications capability in a wireless communication system, comprising the steps of:
(a) automatically transmitting a call origination signal from a wireless device to a base station, wherein the call origination signal contains a request for a data service;
(b) detecting at the wireless device whether a reply to the call origination signal has been received from the base station;
(c) if a reply has been received, detecting whether the data service request has been rejected; and
(d) if the detected reply does not reject the data service request, then displaying on the wireless device an indication of availability of the data service.

2. The method of claim 1, further comprising the step of:
(e) if the detected reply rejects the data service request, then displaying on the wireless device an indication of unavailability of the data service.

3. A method for determining data service connectivity in a wireless communication system, comprising the steps of:
(a) automatically transmitting a call origination signal from a wireless device to a base station requesting data services;
(b) receiving a response from the base station; and
(c) displaying a symbol on a display of the wireless device indicating whether data service connectivity is available.

4. The method of claim 3, wherein step (b) further comprises the step of receiving a traffic channel assignment message from the base station.

5. The method of claim 4, further comprising the step of detecting data service availability.

6. The method of claim 5, wherein step (c) further comprises the step of displaying a symbol indicating that data service connectivity is available in the wireless communication system.

7. The method of claim 4, further comprising the step of releasing the call origination signal.

8. The method of claim 3, wherein step (b) further comprises the step of receiving a release order from the base station, wherein the release order specifies that a requested service option is not supported.

9. The method of claim 8, further comprising the step of automatically transmitting another call origination signal using another service option.

10. The method of claim 3, wherein step (b) further comprises the step of receiving a release order from the base station, wherein the release order does not provide a reason for failing to provide data service connectivity.

11. The method of claim 10, further comprising the step of automatically transmitting another call origination signal according to a backoff algorithm.

12. A method for a wireless device to determine whether data service connectivity is available in a wireless communication system, comprising the steps of:
(a) acquiring the wireless communication system using the wireless device;
(b) determining a system identification/network identification (SID/NID) for the wireless communication system;
(c) comparing the wireless communication system SID/NID with a SIDINID database stored in the wireless device;
(d) displaying on a user-interface of the wireless device a symbol representing the availability of data service connectivity in the wireless communication system if the wireless communication system SID/NID is found in the SID/NID database and the SID/NID has not expired; and
(e) determining data service connectivity for the wireless communication system if one of the wireless communication system SID/NID is not found in the SID/NID database and the SID/NID has expired.

13. The method of claim 12, further comprising the step of resetting all timers if the wireless communication system is either lost, has not been acquired, or has a change in SID/NID.

14. The method of claim 12, wherein step (e) comprises the steps of:
(1) automatically originating a data service request call from the wireless device to a base station using a first data service option;
(2) detecting whether data service connectivity is available upon receipt of a reply from the base station; and
(3) displaying a symbol on the user-interface of the wireless device indicating whether data service connectivity is available.

15. The method of claim 14, wherein step (e)(2) further comprises the step of detecting that data service connectivity is available when a traffic channel assignment is received from the base station.

16. The method of claim 15, further comprising the step of immediately releasing the data service request call upon receipt of the traffic channel assignment from the base station.

17. The method of claim 14, wherein step (e)(2) further comprises the step of detecting that data service connectivity is not available when a release order is received from the base station, wherein the release order specifies that a requested service option is not supported.

18. The method of claim 17, further comprising the step of automatically transmitting another data service request call using another service option, if other service options have been configured for the wireless device.

19. The method of claim 14, wherein step (e)(2) further comprises the step of detecting that data service connectivity is not available when a release order is received from the base station, wherein the release order does not provide a reason for failing to provide data service connectivity.

20. The method of claim 19, further comprising the step of automatically transmitting another data service request call according to a backoff algorithm, wherein the backoff algorithm causes the wireless device to automatically transmit another data service request call when a timer has expired.

21. The method of claim 20, wherein said step of automatically transmitting another data service request call according to a backoff algorithm comprises the step of automatically transmitting another data service request call using a linear backoff algorithm.

22. The method of claim 14, further comprising the step of updating the SID/NID database stored in the wireless device to reflect information obtained for the SID/NID of the wireless communication system.

23. A computer program product comprising a computer useable medium having computer program logic recorded thereon for enabling a computer, operating inside of a wireless device, to determine data service connectivity in a wireless communication system, said computer program logic comprising:
means for enabling the computer to automatically transmit a call origination signal from a wireless device to a base station requesting data services;
means for enabling the computer to receive a response from the base station; and
means for enabling the computer to display a symbol on a display of the wireless device indicating whether data service connectivity is available.

24. The computer program product of claim 23, wherein said means for enabling the computer to receive a response from the base station comprises means for enabling the computer to receive a traffic channel assignment message from the base station.

25. The computer program product of claim 24, further comprising means for enabling the computer to detect data service availability.

26. The computer program product of claim 25, wherein said means for enabling the computer to display a symbol on a display of the wireless device indicating whether data service connectivity is available further comprises means for enabling the computer to display a symbol indicating that data service connectivity is available in the wireless communication system.

27. The computer program product of claim 24, further comprising means for enabling the computer to release the call origination signal.

28. The computer program product of claim 23, wherein said means for enabling the computer to receive a response from the base station comprises means for enabling the computer to receive a release order from the base station, wherein the release order specifies that a requested service option is not supported.

29. The computer program product of claim 28, further comprising means for enabling the computer to automatically transmit another call origination signal using another service option.

30. The computer program product of claim 23, wherein said means for enabling the computer to receive a response from the base station further comprises means for enabling the computer to receive a release order from the base station, wherein the release order does not provide a reason for failing to provide data service connectivity.

31. The computer program product of claim 30, further comprising means for enabling the computer to automatically transmit another call origination signal according to a backoff algorithm.

32. A computer program product comprising a computer useable medium having computer program logic recorded thereon for enabling a computer, operating inside of a wireless device, to determine whether data service connectivity is available in a wireless communication system, said computer program logic comprising:
means for enabling the computer to acquire the wireless communication system using the wireless device;
means for enabling the computer to determine a system identification/network identification (SID/NID) for the wireless communication system;
means for enabling the computer to compare the wireless communication system SID/NID with a SID/NID database stored in the wireless device;
means for enabling the computer to display on a user-interface of the wireless device a symbol representing the availability of data service connectivity in the wireless communication system if the wireless communication system SID/NID is found in the SID/NID database and the SID/NID has not expired; and
means for enabling the computer to determine data service connectivity for the wireless communication system if one of the wireless communication system SID/NID is not found in the SID/NID database and the SID/NID has expired.

33. The computer program product of claim 32, further comprising means for enabling the computer to reset all timers if the wireless communication system is either lost, has not been acquired, or has a change in SID/NID.

34. The computer program product of claim 32, wherein said means for enabling the computer to determine data service connectivity for the wireless communication system if one of the wireless communication system SID/NID is not found in the SID/NID database and the SID/NID has expired comprises:
means for enabling the computer to automatically originate a data service request call from the wireless device to a base station using a first data service option;
means for enabling the computer to detect whether data service connectivity is available upon receipt of a reply from the base station; and
means for enabling the computer to display a symbol on the user-interface of the wireless device indicating whether data service connectivity is available.

35. The method of claim 34, wherein said means for enabling the computer to detect whether data service connectivity is available upon receipt of a reply from the base station further comprises means for enabling the computer to detect that data service connectivity is available when a traffic channel assignment is received from the base station.

36. The method of claim 35, further comprising means for enabling the computer to immediately release the data service request call upon receipt of the traffic channel assignment from the base station.

37. The method of claim 34, wherein said means for enabling the computer to detect whether data service connectivity is available upon receipt of a reply from the base station further comprises means for enabling the computer to detect that data service connectivity is not available when a release order is received from the base station, wherein the release order specifies that a requested service option is not supported.

38. The method of claim 37, further comprising means for enabling the computer to automatically transmit another data service request call using another service option, if other service options have been configured for the wireless device.

39. The method of claim 34, wherein said means for enabling the computer to detect whether data service connectivity is available upon receipt of a reply from the base station further comprises means for enabling the computer to detect that data service connectivity is not available when a release order is received from the base station, wherein the release order does not provide a reason for failing to provide data service connectivity.

40. The method of claim 39, further comprising means for enabling the computer to automatically transmit another data service request call according to a backoff algorithm, wherein the backoff algorithm causes the wireless device to automatically transmit another data service request call when a timer has expired.

41. The method of claim 40, wherein said means for enabling the computer to automatically transmit another data service request call according to a backoff algorithm comprises means for enabling the computer to automatically transmit another data service request call using a linear backoff algorithm.

42. The method of claim 34, further comprising means for enabling the computer to update the SID/NID database stored in the wireless device to reflect information obtained for the SID/NID of the wireless communication system.
